(19) United States
(12) Patent Application Publication
(10) Pub. No.: US 2023/0022062 A1
(43) Pub. Date: Jan. 26, 2023

(54) INFORMATION PROCESSING DEVICE, CONTROL METHOD, AND STORAGE MEDIUM

(71) Applicant: NEC Corporation, Minato-ku, Tokyo (JP)

(72) Inventor: Kei SHIBUYA, Tokyo (JP)

(73) Assignee: NEC Corporation, Minato-ku, Tokyo (JP)

(21) Appl. No.: 17/791,726

(22) PCT Filed: Jan. 22, 2020
(86) PCT No.: PCT/JP2020/002104

§ 371 Date: Jul. 8, 2022

(51) Int. Cl. G06Q 10/06

(52) U.S. Cl. CPC G06Q 10/06395

(57) ABSTRACT

The information processing device 1C mainly includes the biological information acquisition unit 30C, the state coincidence determination unit 35C, and the meeting score calculation unit 37C. The biological information acquisition unit 30C is configured to acquire biological information Ib of multiple participants in a meeting. The state coincidence determination unit 35C is configured to determine, based on the biological information Ib, whether or not there is a state coincidence among the multiple participants in the meeting and generate the state coincidence information Im relating to the state coincidence. The meeting score calculation unit 37C is configured to calculate, based on the state coincidence information Im, a meeting score Sc indicating an evaluation of a quality of the meeting according to a purpose of the meeting.

### TECHNICAL FIELD

The present invention relates to a technical field of an information processing device, a control method, and a storage medium for processing information on a meeting.

### BACKGROUND ART

A method for estimating the state of participants in a meeting by acquiring biological information of the participants in the meeting has been proposed. For example, Patent Literature 1 discloses a conversation satisfaction estimation device configured to extract a speaking text from speech data during a conversation and estimate a degree of satisfaction of a specific speaker during the conversation on the basis of a transition of intentions of the speak estimated from the extracted speaking text.

### CITATION LIST

### Patent Literature

Patent Literature 1: JP 2018-169506A

### SUMMARY

### Problem to be Solved

To improve the quality of a meeting, it is necessary to precisely evaluate the quality of the meeting that have been held. Patent Literature 1 discloses a technique of measuring an individual satisfaction of a participant of a meeting, but it is silent on performing an evaluation on the entire meeting.

In view of the above-described issue, it is therefore an example object of the present disclosure to provide an information processing device, a control method and a storage medium capable of suitably evaluating the quality of a meeting.

### Means for Solving the Problem

In one mode of the information processing device, there is provided an information processing device including: a biological information acquisition unit configured to acquire biological information of multiple participants in a meeting; a state coincidence determination unit configured to determine, based on the biological information, whether or not there is a state coincidence among the multiple participants in the meeting and generate state coincidence information relating to the state coincidence; and a meeting score calculation unit configured to calculate, based on the state coincidence information, a meeting score indicating an evaluation of a quality of the meeting according to a purpose of the meeting.

In one mode of the control method, there is provided a control method executed by an information processing device, the control method including: acquiring biological information of multiple participants in a meeting; determining, based on the biological information, whether or not there is a state coincidence among the multiple participants in the meeting and generate state coincidence information relating to the state coincidence; and calculating, based on the state coincidence information, a meeting score indicating an evaluation of a quality of the meeting according to a purpose of the meeting.

In one mode of the storage medium, there is provided a storage medium storing a program executed by a computer, the program causing the computer to function as: a biological information acquisition unit configured to acquire biological information of multiple participants in a meeting; a state coincidence determination unit configured to determine, based on the biological information, whether or not there is a state coincidence among the multiple participants in the meeting and generate state coincidence information relating to the state coincidence; and a meeting score calculation unit configured to calculate, based on the state coincidence information, a meeting score indicating an evaluation of a quality of the meeting according to a purpose of the meeting.

### Effect

An example advantage according to the present invention is to suitably calculate a meeting score for evaluating the quality of a meeting depending on the purpose of the meeting.

### BRIEF DESCRIPTION OF THE DRAWINGS

FIG. 1 illustrates the configuration of a meeting evaluation system.

FIG. 2A illustrates the block configuration of an information processing device.

FIG. 2B illustrates the block configuration of a display terminal.

FIG. 3 is an example of a functional block of a processor of the information processing device.

FIG. 4 is a graph showing the variation with time in the biomarker of meeting participants during the meeting when the purpose in the meeting is a brainstorming.

FIG. 5 is a graph showing the variation with time in the biomarker of the meeting participants during the meeting when the purpose of the meeting is a consensus formation.

FIG. 6 is a graph showing the variation with time in the biomarker of the meeting participants during the meeting when the purpose of the meeting is a presentation.

FIG. 7 is an example of a flowchart showing the procedure of the meeting analysis process relating to the calculation of the meeting score.

FIG. 8 is a display example of a meeting evaluation list view.

FIG. 9 is a display example of an individual meeting evaluation view.

FIG. 10 is a display example of a meeting evaluation comparison view.

FIG. 11 illustrates the configuration of the meeting evaluation system according to a second example embodiment.

FIG. 12 is a functional block diagram of a processor of an information processing device according to a third example embodiment.

FIG. 13 is an example of a flowchart showing the procedure of the meeting analysis process in the third example embodiment.

FIG. 14 is a schematic configuration diagram of an information processing device according to a fourth example embodiment.

### EXAMPLE EMBODIMENTS

Hereinafter, an example embodiment of an information processing device, a control method, and a storage medium will be described with reference to the drawings.

### First Example Embodiment

### (1) System Configuration

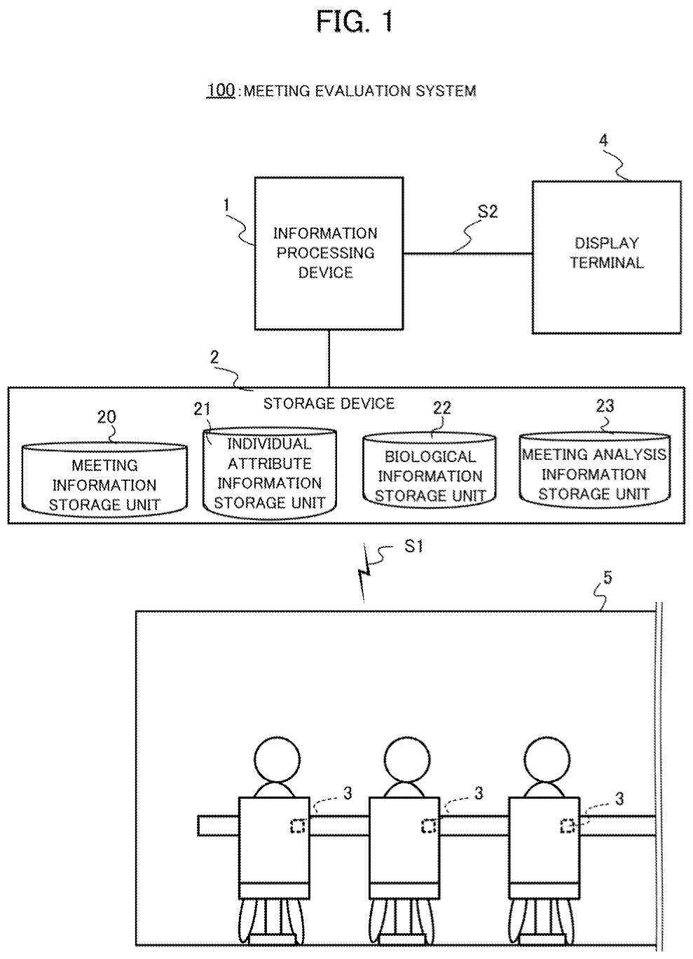

FIG. 1 shows the configuration of a meeting evaluation system 100 according to the first example embodiment. The meeting evaluation system 100 is a system configured to evaluate the quality of a meeting based on the biological information of participants (also referred to as “meeting participants”) of the meeting in a meeting room 5. The meeting evaluation system 100 mainly includes an information processing device 1, a storage device 2, a biological information detection sensor 3 for detecting the biological information of the meeting participants, and a display terminal 4 configured to make a display request regarding the evaluation of the quality of the meeting to the information processing device 1. The meeting room 5 may be any space in which a meeting is held, and may be, for example, an open meeting space which is not surrounded by a wall and which is present in a living room.

The information processing device 1 refers to information stored in the storage device 2 and generates a display signal “S2” to be transmitted to the display terminal 4, and transmits the display signal S2 to the display terminal 4. In this case, the information processing device 1 calculates a score (also referred to as “meeting score Sc”) indicating the evaluation of the quality of the meeting for each meeting. Here, as will be described later, the information processing device 1 calculates the meeting score Sc in accordance with the purpose of the meeting of interest.

The biological information detection sensor 3 is provided for each meeting participant and transmits a detection signal “S1” indicating the biological information of the each meeting participant during the meeting to the information processing device 1 or the storage device 2. The biological information detection sensor 3 may be a wearable sensor worn by the each meeting participant at the time of the meeting, or may be a sensor incorporated in the chair in which the each meeting participant sits. Further, in some embodiments, the biological information detection sensor 3 includes, in the detection signal S1, the identification information (i.e., personal ID) of the each meeting participant subject to detection of the biological information by the biological information detection sensor 3. The personal ID may be an ID allocated by an organization (company) to which the customer belongs, or may be an ID allocated by a public organization, or may be identification information utilized in any biometric certification such as face certification, iris certification, and fingerprint certification. In this case, the biological information detection sensor 3 may acquire the personal ID of the each meeting participant in advance of the meeting by receiving user input, or may acquire the identification information of the each meeting participant in advance of the meeting through any biometric certification for the each meeting participant such as fingerprint certification, iris certification, and the like. Further, the biological information detection sensor 3 includes, in the detection signal S1, not only the personal ID of the each meeting participant but also time information indicative of the detection time of the biological information and identification information (e.g., device ID) of the biological information detection sensor 3.

The storage device 2 stores information necessary for the information processing device 1 to calculate the meeting score Sc. The storage device 2 functionally includes a meeting information storage unit 20, an individual attribute information storage unit 21, a biological information storage unit 22, and a meeting analysis information storage unit 23.

The meeting information storage unit 20 stores the meeting information, which is basic information regarding meetings to be held or already held. The meeting information is, for example, the reservation information specified via the meeting reservation system (not shown) in advance of the meeting. Examples of the meeting information include information such as the identification information (meeting ID) of the meeting, the identification information (meeting room ID) of the meeting room to be used, the reservation date and time, the length of the meeting time, and the personal ID of each meeting participant. In some embodiments, the meeting information may further include information indicative of the purpose of the meeting. Examples of the purpose of the meeting include a brainstorming to come up with new ideas, a consensus formation to form meeting participants' consensus on ideas regarding a predetermined topic, and presentations to be made by a presenter to share his or her ideas with other meeting participants.

It is noted that the information processing device 1 may automatically generate the above-described meeting information and store the generated meeting information in the meeting information storage unit 20 by recognizing the meeting participants and the time period of the meeting based on time-series detection signals S1 generated by the biological information detection sensor 3 during the meeting. In this case, the detection signal S1 includes time information indicating the detection time and the personal ID of the meeting participants subject to detection. Further, as will be described later, the information processing device 1 may determine the purpose of the meeting based on the signal outputted by a camera or an audio input device provided in the meeting, and store the above-described meeting information including the result of the above determination in the meeting information storage unit 20.

The individual attribute information storage unit 21 stores attribute information of each individual person that is a possible meeting participant. The attribute information stored in the individual attribute information storage unit 21 is used for weighting the degree of synchronization (attunement) between any two participants to be described later. The attribute information stored in the individual attribute information storage unit 21 is, for example, information indicating one or more attributes of each individual person relating to the difficulty level of the synchronization among participants such as position, age, job type, gender, and personality. The individual attribute information storage unit 21 stores the attribute information in association with the corresponding personal ID.

The biological information storage unit 22 stores the biological information of each meeting participant during the meeting. The biological information stored in the biological information storage unit 22 is, for example, time series data of the pulse of the each meeting participant in the meeting. It is noted that the biological information is not limited to the pulse and it may be any other time-series data of the meeting participants during the meeting such as brain waves and amount of perspiration. The biological information storage unit 22 stores the biological information of each meeting participant generated during the meeting based on the detection signal S1 generated during the meeting by the biological information detection sensor 3. The detection signal S1 may be transmitted to the information processing device 1 or may be transmitted to the storage device 2. In the former case, the information processing device 1 stores the biological information based on the received detection signal S1 in the biological information storage unit 22.

Further, the biological information storage unit 22 stores the biological information of each meeting participant in association with the personal ID of the each meeting participant and the time information included in the corresponding detection signal S1. Further, the biological information storage unit 22 may store, in the biological information storage unit 22, the meeting ID of the meeting where the detection signal S1 is generated in association with the biological information based on the detection signal S1. The meeting ID is identified, for example, based on the meeting information (e.g., time period of the meeting) stored in the meeting information storage unit 20 and time information included in the detection signal S1. In the case where the detection signal S1 includes information (e.g., the device ID of the biological information detection sensor 3 associated with the meeting ID of the meeting room 5) with which the meeting room 5 information can be identified, the meeting ID may be identified with further reference to the above-mentioned information and the meeting information indicative of the meeting room.

The meeting analysis information storage unit 23 stores meeting analysis information indicating the analysis result generated by the information processing device 1 for each meeting held. The meeting analysis information may include: information on the degree of synchronization between any two (i.e., a pair of) meeting participants calculated based on the biological information stored in the biological information storage unit 22; information on the meeting score Sc; and any other information necessary for the information processing device 1 to generate the display signal S2.

The storage device 2 may store not only information stored in the meeting information storage unit 20, the individual attribute information storage unit 21, the biological information storage unit 22, and the meeting analysis information storage unit 23 but also any other information necessary for the information processing device 1 to calculate the meeting score Sc and generate the display signal S2.

The storage device 2 may be an external storage device such as a hard disk connected to or built in to the information processing device 1, or may be a storage medium such as a flash memory that is detachable from the information processing device 1. The storage device 2 may include one or more server devices that perform data communication with the information processing device 1. Further, the information stored in the storage device 2 may be dispersedly stored by a plurality of devices or storage media.

The display terminal 4 is a terminal used by a person who browses the evaluation of the meeting held, and displays, based on the display signal S2 supplied from the information processing device 1, information on the evaluation of the meeting held.

The configuration of the meeting evaluation system 100 shown in FIG. 1 is an example, and various changes may be applied to the configuration. For example, the information processing device 1 and the storage device 2 may be configured by one device. Similarly, the information processing device 1 and the display terminal 4 may be configured by one device. Further, the information processing device 1 may be configured by a plurality of devices. In this case, the plurality of devices functioning as the information processing device 1 exchange information necessary for executing the pre-allocated processing among the plurality of devices.

### (2) Block Configuration

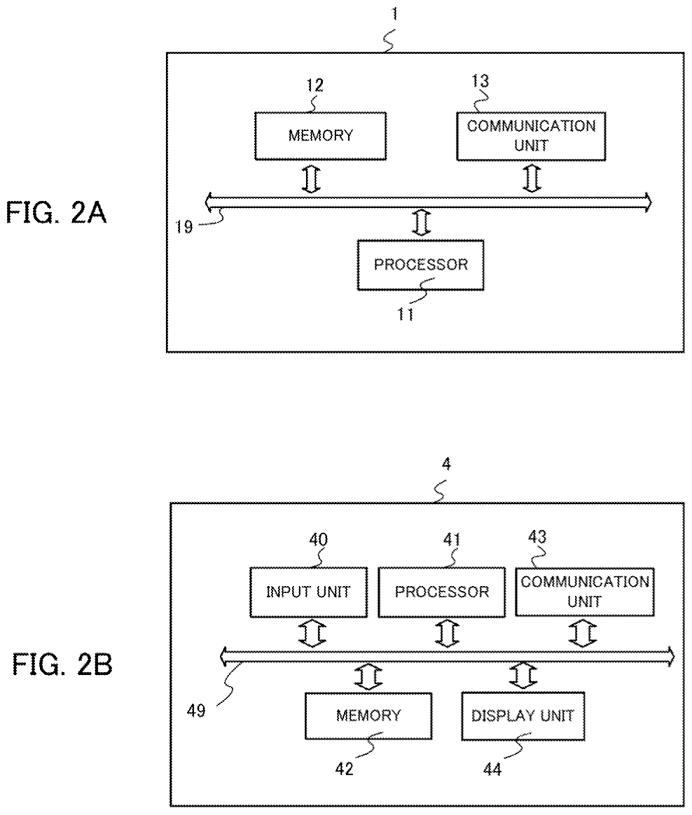

FIG. 2A shows an example of a block configuration of the information processing device 1. The information processing device 1 includes, as hardware, a processor 11, a memory 12, and a communication unit 13. The processor 11, the memory 12, and the communication unit 13 are connected to one another via a data bus 19.

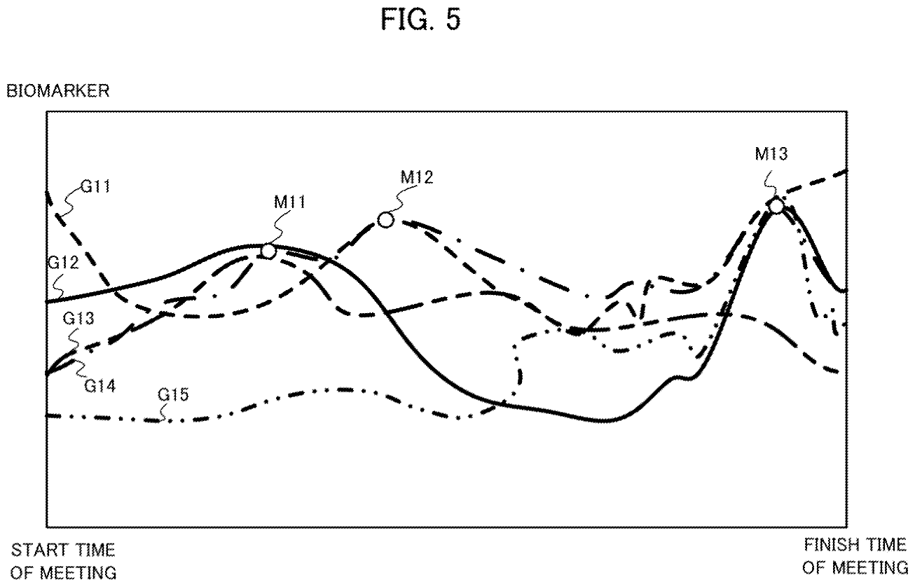

The processor 11 executes a predetermined process by executing a program stored in the memory 12. The processor 11 is one or more processors such as a CPU (Central Processing Unit) and a GPU (Graphics Processing Unit). The process executed by the processor 11 will be described in detail with reference to the functional block diagram shown in FIG. 5.

The memory 12 is configured by various memories such as a RAM (Random Access Memory), a ROM (Read Only Memory), and a nonvolatile memory. In addition, a program for the information processing device 1 to execute a predetermined process is stored in the memory 12. The memory 12 includes a work memory and temporarily stores information acquired from the storage device 2. The memory 12 may function as a storage device 2. Similarly, the storage device 2 may function as a memory 12 of the information processing device 1. The program executed by the information processing device 1 may be stored in a storage medium other than the memory 12.

The communication unit 13 is a communication module or an interface connected to the communication module to be used for the information processing device 1 performing data communication with external devices such as the storage device 2, the biological information detection sensor 3, and the display terminal 4.

The configuration of the information processing device 1 is not limited to the configuration shown in FIG. 2A. For example, the information processing device 1 may incorporate or be connected to at least one of an input unit for receiving an input by a user, a display unit such as a display, or a sound output device such as a speaker. For example, the information processing device 1 may be a tablet type terminal or the like in which the input function and the output function are integrated with the main body.

FIG. 2B shows an example of a block configuration of the display terminal 4. The display terminal 4 includes, as hardware, an input unit 40, a processor 41, a memory 42, a communication unit 43, and a display unit 44. Each element of the display terminal 4 is connected to one another via a data bus 49.

The input unit 40 receives an input or the like by the viewer to specify information to be displayed on the display terminal 4. Examples of the input unit 40 include a button, a switch, a touch panel, a voice input device, and an interface for connecting to any one of them. The processor 41 executes a predetermined process by executing a program stored in the memory 42. The processor 41 is one or more processors such as a CPU, a GPU, and the like. The memory 42 is configured by various memories such as a RAM, a ROM, and a non-volatile memory. Further, the memory 42 stores a program for the display terminal 4 to execute a predetermined process. The memory 42 also includes a working memory.

The communication unit 43 is a communication module for the display terminal 4 to communicate with other devices such as the information processing device 1 or an interface for the display terminal 4 to be electrically connected to the communication module. Examples of the display unit 44 include a display, a projector, and an interface for electrically connecting the display terminal 4 thereto.

### (3) Functional Block

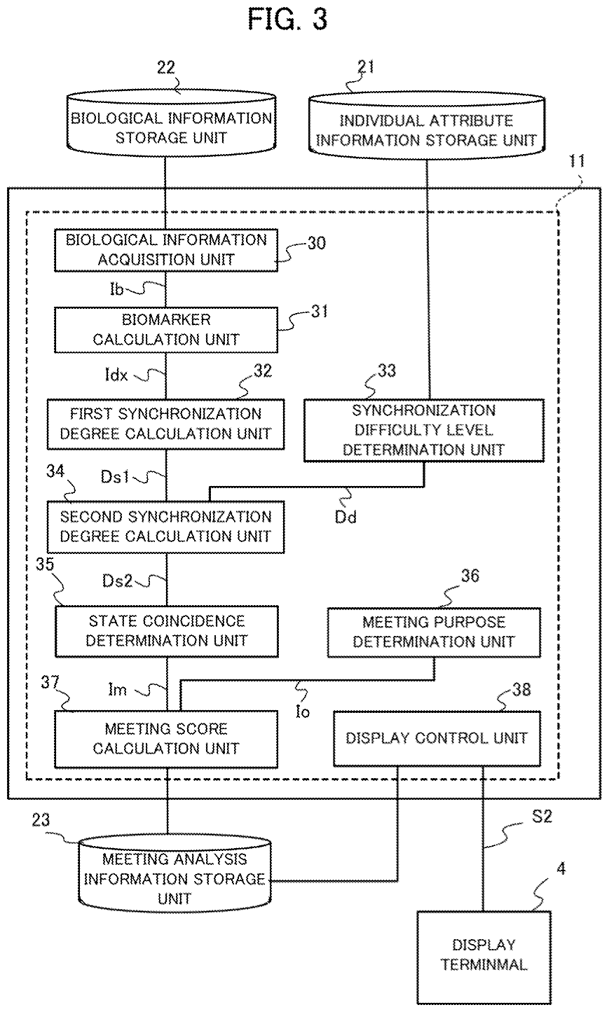

FIG. 3 is an example of a functional block of the processor 11 of the information processing device 1. The processor 11 of the information processing device 1 functionally includes a biological information acquisition unit 30, a biomarker (biological indicator) calculation unit 31, a first synchronization degree calculation unit 32, an synchronization difficulty level determination unit 33, a second synchronization degree calculation unit 34, a state coincidence (accordance) determination unit 35, a meeting purpose determination unit 36, a meeting score calculation unit 37, and a display control unit 38.

The biological information acquisition unit 30 acquires, from the biological information storage unit 22, time-series biological information “Ib” of the meeting participants during the meeting in which the meeting score Sc should be calculated. Examples of the meeting subject to calculation of the meeting score Sc may include a meeting designated by the display request received from the display terminal 4 and a meeting immediately after the end (i.e., the meeting immediately after the transmission of the detection signal S1 is completed). For example, by referring to the meeting information storage unit 20, the biological information acquisition unit 30 recognizes the time period in which the meeting subject to calculation of the meeting score Sc is held, and acquires, from the biological information storage unit 22, the time series biological information Ib of each meeting participant during the meeting acquired in the time period.

The biomarker calculation unit 31 converts the biological information Ib of each meeting participant acquired by the biological information acquisition unit 30 into a biological indicator (also referred to as “biomarker Idx”) suitable for calculating the degree of synchronization between participants. Examples of this biomarker Idx include a degree of arousal (i.e., a degree of tension), and an indicator of a degree of comfort or discomfort (i.e., a degree of positiveness). Thus, the biomarker calculation unit 31 generates time series data of the biomarker Idx of each meeting participant during the meeting.

The first synchronization degree calculation unit 32 calculates the degree (also referred to as “first synchronization degree Ds1”) of synchronization between meeting participants based on the time series data of the biomarker Idx of the meeting participants during the meeting generated by the biomarker calculation unit 31. The first synchronization degree Ds1 indicates the degree of synchronization between the meeting participants before the weighting based on the synchronization difficulty level to be described later.

Here, a description will be given of a calculation method of the first synchronization degree Ds1. The first synchronization degree calculation unit 32 calculates the first synchronization degree Ds1 for all possible combinations (i.e., ₙC₂ combinations where the number of meeting participants is “n”) of pairs selected from the meeting participants of the target meeting. In this case, for example, the first synchronization degree calculation unit 32 calculates time series values of the first synchronization degrees Ds1 during the meeting through a process of comparing (matching) the time series data of the biomarker Idx for each pair of the meeting participants. Specifically, for example, the first synchronization degree calculation unit 32 divides the time period in which the meeting is held into time slots each having a predetermined time length, and calculates a cross-correlation function, in which the time difference (time lag) is set as a variable, using time series data of the biomarker Idx of two meeting participants generated during each time slot. Then, for example, the first synchronization degree calculation unit 32 calculates, for each time slot, a maximum value or a normalized maximum value of positive correlation indicated by the positive correlation function within the range of a predetermined time difference, and sets the calculated value as the first synchronization degree Ds1 for each time slot. For example, the above-mentioned time difference is determined in advance in consideration of the maximum time difference between the time one of the meeting participants has spoken and the time other meeting participants react thereto. It is noted that the first synchronization degree calculation unit 32 may determine the time to calculate the first synchronization degree Ds1 to be at predetermined time intervals and calculate the first synchronization degree Ds1 at each determined time. In this case, for example, the first synchronization degree calculation unit 32 determines, for each time determined to calculate the first synchronization degree Ds1, a time slot (i.e., a moving window) having a predetermined time length centered on the each time. Then, the first synchronization degree calculation unit 32 calculates the cross-correlation function, in which the time lag is set as a variable, of the time series data of the biomarker Idx of the target two meeting participants in the time slot determined for each determined time. Then, the first synchronization degree calculation unit 32 calculates a maximum value or a normalized maximum value of the positive correlation indicated by the cross-correlation function within a range of the predetermined time lag for each time slot (i.e., each moving window) set for each time determined to calculate the first synchronization degree Ds1. In this case, the time slot set (i.e., the moving window) for each time determined to calculate the first synchronization degree Ds1 may overlap with other neighboring time slots. Thus, the first synchronization degree calculation unit 32 may apply a moving window allowed to overlap (or not overlap) during the time period in which the meeting is held to thereby calculate the first synchronization degree Ds1 according to any time interval.

The first synchronization degree calculation unit 32 may calculate the first synchronization degree Ds1 between the meeting participants from the time series data of the biomarker Idx of the target meeting participants based on any algorithm, other than the cross-correlation function, for calculating the degree of similarity (degree of correlation) of the two time series data. Further, if multiple types of the biomarker Idx is calculated by the biomarker calculation unit 31, the first synchronization degree calculation unit 32 calculates the degree of similarity (degree of correlation) of the time-series data for each type of the biomarker Idx. The first synchronization degree calculation unit 32 calculates the first synchronization degree Ds1 through statistical processing, such as ensemble averaging, on the degrees of similarity calculated for respective types of the biomarker Idx.

On the basis of the attribute information of the meeting participants acquired from the individual attribute information storage unit 21, the synchronization difficulty level determination unit 33 determines the difficulty level (also referred to as “synchronization difficulty level Dd”) of synchronization for each pair of meeting participants between which the first synchronization degree Ds1 was calculated.

A specific example of the determination method of the synchronization difficulty level Dd will be described. In the first example, the synchronization difficulty level determination unit 3 identifies the position or post of each meeting participant with reference to the individual attribute information storage unit 21, and the farther the positions or posts of a pair of the meeting participants are, the higher synchronization difficulty level Dd the synchronization difficulty level determination unit 3 sets. In this case, for example, the synchronization difficulty level determination unit 33 quantifies the position or the post of each meeting participant with reference to a map or the like, and calculates the synchronization difficulty level Dd by referring to a predetermined equation or a map (i.e., look-up table) from the difference between the quantified positions or posts.

In a second example, the synchronization difficulty level determination unit 33 determines the synchronization difficulty level Dd based on the job type of each meeting participant. In this case, by referring to the map indicating the correspondence between each possible pair of the job types of meeting participants and the synchronization difficulty level Dd, the synchronization difficulty level determination unit 33 calculates the synchronization difficulty level Dd between the target meeting participants from the job types of the target meeting participants identified with reference to the individual attribute information storage unit 21. In this case, for example, the higher the degree of similarity between two job types is, the lower synchronization difficulty level Dd the synchronization difficulty level determination unit 3 sets. In the third example, the synchronization difficulty level determination unit 33 determines the synchronization difficulty level Dd based on the age of each meeting participant. In this case, the synchronization difficulty level determination unit 33 refers to the equation or the map or the like, and the larger the difference between the ages of the meeting participants is, the higher synchronization difficulty level Dd the synchronization difficulty level determination unit 3 sets.

In the fourth example, the synchronization difficulty level determination unit 33 determines the synchronization difficulty level Dd based on multiple attributes of each meeting participant. Examples of the above-mentioned multiple attributes include any combination of at least two selected from the position or post in the first example, the job type in the second example, the age in the third example, and any other types of attributes. In this case, for example, the synchronization difficulty level determination unit 33 quantifies each attribute with reference to a predetermined map or the like, and calculates the synchronization difficulty level Dd based on the calculation formula of the synchronization difficulty level Dd using the quantified attribute as a variable. In the fourth example, instead of using the above-described calculation formula of the synchronization difficulty level Dd, the synchronization difficulty level determination unit 33 may refer to a predetermined map and determine the synchronization difficulty level Dd from a combination of attributes of the meeting participants. The above-mentioned equation, formula, or map in the first to fourth examples are stored in advance in the storage device 2 or the memory 12.

The second synchronization degree calculation unit 34 calculates, for each pair of the meeting participants of the target meeting, the degree (also referred to as “second synchronization degree Ds2”) of synchronization that is the first synchronization degree Ds1 weighted on the basis of the synchronization difficulty level Dd supplied from the synchronization difficulty level determination unit 33, wherein the first synchronization degree Ds1 is supplied from the first synchronization degree calculation unit 32. In this case, the second synchronization degree calculation unit 34 calculates, for each pair of the meeting participants, the second synchronization degree Ds2 by multiplying the corresponding first synchronization degree Ds1 by the corresponding synchronization difficulty level Dd. The first synchronization degree Ds1 is a first time-series value during the meeting, and the second synchronization degree calculation unit 34 calculates, as the second synchronization degree Ds2, a second time-series value obtained by multiplying each first time-series value by the corresponding synchronization difficulty level Dd.

The state coincidence determination unit 35 determines whether or not there is a state coincidence among participants, and supplies information (also referred to as “state coincidence information Im”) indicating the determination result to the meeting score calculation unit 37. Specifically, for each possible pair of the meeting participants, the state coincidence determination unit 35 detects a time or a time slot during a meeting in which the corresponding second synchronization degree Ds2 is equal to or greater than a predetermined threshold value (also referred to as “state coincidence threshold Dsth”) as a time or a time slot in which the states of the target meeting participants coincide with each other. Then, the state coincidence determination unit 35 supplies, for each possible pair of the meeting participants, information indicating the time or the time slot in which the states of the meeting participants coincide to the meeting score calculation unit 37 as the state coincidence information Im. In this case, by determining whether or not there is a state coincidence between the meeting participants based on the second synchronization degree Ds2 that is determined in consideration of the synchronization difficulty level Dd, the state coincidence determination unit 35 can accurately determine whether or not there is a substantial state coincidence in view of the difficulty level of synchronization between participants.

The meeting purpose determination unit 36 determines(identifies) the purpose of the target meeting and supplies information (also referred to as “meeting purpose information Io”) indicating the identified purpose of the meeting to the meeting score calculation unit 37. For example, if the meeting information stored in the meeting information storage unit 20 includes the information on the purpose of the meeting, the meeting purpose determination unit 36 identifies the purpose of the target meeting by referring to the meeting information for the target meeting from the meeting information storage unit 20.

In another example of determining the purpose of the meeting, the meeting purpose determination unit 36 may estimate the purpose of the target meeting based on the voice data generated during the target meeting by the voice input device (not shown) provided in the meeting room 5. For example, the meeting purpose determination unit 36 may extract words from the voice data detected in the beginning portion or the like of the meeting and estimate the purpose of the meeting based on the extracted words. In this case, for example, the meeting purpose determination unit 36 holds a list of words corresponding to each purpose of the meeting in advance in the memory 12 or the like, and searches the list described above for the words extracted from the detected voice data, thereby estimating the purpose of the meeting. In another example, the meeting purpose determination unit 36 may use an inference engine learned in advance to infer the purpose of the meeting from words in the meeting by machine learning such as deep learning. The meeting purpose determination unit 36 inputs the words extracted from the voice data detected during the meeting to the inference engine thereby to estimate the purpose of the meeting.

In addition, the meeting purpose determination unit 36 may estimate the purpose of the meeting by analyzing the image generated by a camera provided to photograph the meeting room 5. In this case, for example, the meeting purpose determination unit 36 uses an inference engine previously learned to infer the purpose of the meeting from an image in the meeting room 5 during the meeting by machine learning such as deep learning. The meeting purpose determination unit 36 inputs the image taken during the meeting into the inference engine, thereby estimating the purpose of the meeting. Generally, the arrangement of the meeting participants in the meeting room 5 depending on the purpose of the meeting (e.g., the presenter stands near the view in the case of a presentation, etc.). Thus, the meeting purpose determination unit 36 can estimate the purpose of the meeting by analyzing the image generated by the camera provided to photograph the meeting room 5.

The meeting score calculation unit 37 calculates the meeting score Sc based on the state coincidence information Im generated by the state coincidence determination unit 35 and the meeting purpose information Io generated by the meeting purpose determination unit 36. Specific examples of the calculation method of the meeting score Sc by the meeting score calculation unit 37 will be described later. Then, the meeting score calculation unit 37 associates the meeting score Sc and various information used for the calculation of the calculated meeting score Sc with the meeting ID of the target meeting and stores it as the meeting analysis information in the meeting analysis information storage unit 23. The above-described meeting analysis information includes, for example, information indicating the meeting score Sc, the first synchronization degree Ds1 used for calculating the meeting score Sc, the second synchronization degree Ds2, the synchronization difficulty level Dd, the biomarker Idx, the meeting purpose information Io, a state coincidence information Im, and the like. Such information is suitably used in the display processing by the display control unit 38.

The display control unit 38 refers to the meeting analysis information storage unit 23 and generates a display signal S2 for displaying a view (also referred to as “meeting evaluation view”) relating to the evaluation of the quality of the meeting specified in the display request transmitted from the display terminal 4. Then, the display control unit 38 transmits the display signal S2 to the display terminal 4 to thereby display the meeting evaluation view on the display terminal 4. Specific examples of this meeting evaluation view will be described later.

Incidentally, each component of the biological information acquisition unit 30, the biomarker calculation unit 31, the first synchronization degree calculation unit 32, the synchronization difficulty level determination unit 33, the second synchronization degree calculation unit 34, the meeting score calculation unit 37, and the display control unit 38 described in FIG. 3 can be realized, for example, by the processor 11 executing the program. More specifically, each component may be implemented by the processor 11 executing a program stored in the memory 12. In addition, the necessary programs may be recorded in any nonvolatile recording medium and installed as necessary to realize each component. Each of these components is not limited to being implemented by software using a program, and may be implemented by any combination of hardware, firmware, and software. Each of these components may also be implemented using user programmable integrated circuitry, such as, for example, FPGA (field-programmable gate array) or a microprocessor. In this case, the integrated circuit may be used to realize a program to function as each of the above-described components. Thus, each component may be implemented by hardware other than the processor 11. The above is the same in other example embodiments to be described later.

### (4) Calculation of Meeting Score

The meeting score calculation unit 37 calculates the meeting score Sc according to the purpose of the meeting indicated by the meeting purpose information Io based on the state coincidence information Im. Here, as an example, a description will be given of a method of calculating the meeting score Sc by the meeting score calculation unit 37 when the purpose of the meeting indicated by the meeting purpose information Io is a brainstorming, a consensus formation, or a presentation.

(4-1) Brainstorming

When the purpose of the meeting is a brainstorming, it becomes important in the meeting to give more (diversified) ideas than the quality of each utterance. Therefore, in the present example embodiment, when the purpose of the meeting is a brainstorming, an ideal condition is defined to be a condition in which the state coincidence for each pair of the meeting participants occurs in a dispersed manner during the meeting. Therefore, when the purpose of the meeting is a brainstorming, the meeting score calculation unit 37 calculates the meeting score Sc based on the degree (also referred to as “state coincidence dispersion Vm”) of variation in the timing at which the state coincidence between the meeting participants occurs during the meeting. Further, the meeting score calculation unit 37 further calculates the meeting score Sc based on the number (also referred to as “state coincidence combination number Nm”) of combinations (pairs) of the meeting participants between which a state coincidence occurs.

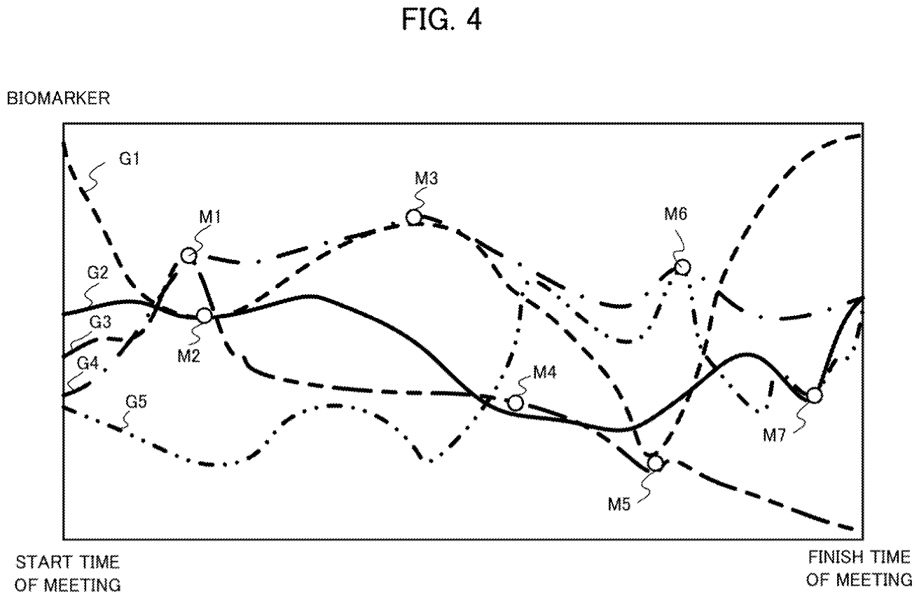

FIG. 4 is a graph showing the variation with time in the biomarker Idx of the meeting participants during the meeting when the purpose of the meeting is a brainstorming. FIG. 4 shows the variation with time in the biomarker Idx of each meeting participant in the meeting held by five persons by graphs “G1” to “G5”, respectively, and explicitly indicates the state coincidence points “M1” to “M7” indicating the positions where the states are determined to synchronize. It is noted that, although only one type of the biomarker Idx is shown for the sake of convenience in FIG. 4, as described above, a plurality of types of the biomarkers Idx may be used for calculation of the first synchronization degree Ds1, the second synchronization degree Ds2, and the state coincidence information Im.

In this case, the state coincidence determination unit 35 generates the state coincidence information Im based on the second synchronization degree Ds2 of all possible pairs (₅C₂=10 pairs) selected from the five meeting participants and the state coincidence threshold Dsth. Here, the state coincidence determination unit 35 detects the state coincidence (see the state coincidence point M1) between the meeting participant corresponding to the graph G3 and the meeting participant corresponding to the graph G4 and the state coincidence (see the state coincidence point M2) between the meeting participant corresponding to the graph G1 and the meeting participant corresponding to the graph G2. Further, the state coincidence determination unit 35 detects other state coincidences indicated by the state coincidence points M3 to M7 in the same way.

Then, the meeting score calculation unit 37 calculates the state coincidence combination number Nm and the state coincidence dispersion Vm, respectively, based on the state coincidence information Im. First, the meeting score calculation unit 37 recognizes that the state coincidence combination number Nm is 7 by counting the number (seven pairs) of pairs of the meeting participants corresponding to the state coincidence points M1 to M7. In addition, for example, regarding the state coincidence dispersion Vm, the meeting score calculation unit 37 normalizes each timing at which each states coincidence occurs to a value ranging from 0 to 1 by associating the time period of the meeting with values ranging from 0 to 1. Then, the meeting score calculation unit 37 calculates the dispersion (variance) of the normalized values at the above-mentioned timings as the state coincidence dispersion Vm. Therefore, the meeting score calculation unit 37 calculates the dispersion of the normalized values at the times corresponding to the state coincidence points M1 to M7 as the state coincidence variance Vm.

The state coincidence combination number Nm tends to increase as the number of meeting participants increases. Therefore, in some embodiments, the meeting score calculation unit 37 may calculate the meeting score Sc without dependence on the number of meeting participants based on the ratio (also referred to as “state coincidence combination ratio Pp”) of the state coincidence combination number Nm to the number of the total possible combinations (pairs) of the meeting participants. Here, the state coincidence combination ratio Pp has a value range in which the minimum value is 0 and the maximum value is 1, regardless of the number of participants in the meeting. In the example of FIG. 4, since the state coincidence combination number Nm is “7” and the number of all possible pairs of the meeting participants are “10”, the state coincidence combination ratio Pp is “0.7” (=7/10). If there are “Na” (Na is 2 or more integer) times of state coincidences between a single pair of the meeting participants, the meeting score calculation unit 37 may determine the above-mentioned state coincidences as Na times in the count of the state coincidence combination number Nm instead of collectively counting them as once. In this case, the maximum value of the state coincidence combination ratio Pp is greater than 1.

The meeting score calculation unit 37 calculates the meeting score Sc from the state coincidence dispersion Vm and the state coincidence combination ratio Pp. In this case, when the state coincidence combination ratio Pp is constant, the meeting score calculation unit 37 determines the meeting score Sc so that the greater the state coincidence dispersion Vm is, the greater the meeting score Sc becomes. In contrast, when the state coincidence dispersion Vm is constant, the meeting score calculation unit 37 determines the meeting score Sc so that the greater the state coincidence combination ratio Pp is, the greater the meeting score Sc becomes. In this case, for example, the meeting score calculation unit 37 may determine the meeting score Sc based on the sum of the state coincidence combination ratio Pp and the state coincidence dispersion Vm by referring to a predetermined equation or map (i.e., look-up table showing the correspondence between the sum and the meeting score Sc). In another example, the meeting score calculation unit 37 multiplies each of the state coincidence combination ratio Pp and the state coincidence dispersion Vm by a predetermined coefficient for weighting or/and normalization of the magnitude and then calculates the sum of them. Then, the meeting score calculation unit 37 determines the meeting score Sc from the calculated sum by referring to a predetermined equation or map (i.e., look-up table showing the correspondence between the sum and the meeting score Sc). The equation or map is used to normalize the sum so that the meeting score Sc to be calculated falls within a predetermined value range, for example, stored in advance in the memory 12 of the information processing device 1 or the storage device 2.

In this way, the meeting score calculation unit 37 can suitably calculate the meeting score Sc when the purpose of the meeting is a brainstorming.

(4-2) Consensus Formation

If the purpose of the meeting is a consensus formation, decision making, such as good/bad, or continuation/interruption, on an idea (or draft) for a certain subject is made within the meeting time by the meeting participants. Therefore, in the present example embodiment, when the purpose of the meeting is a consensus formation, an ideal condition is defined to be a condition in which the state coincidence among as many participants as possible occurs at a certain timing at the same time.

Considering the above, if the purpose of the meeting is a consensus formation, the meeting score calculation unit 37 calculates the meeting score Sc based on the number (also referred to as “simultaneous state coincidence combination number Ns”) of pairs of meeting participants with a state coincidence at each timing when a state coincidence among the meeting participants occurs.

FIG. 5 illustrates graphs indicating the variation with time in the biomarker Idx of the meeting participants during the meeting when the purpose of the meeting is a consensus formation. FIG. 5 shows the variation with time in the biomarker Idx of each meeting participant by the graphs “G11” to “G15” in the meeting held by five persons, respectively, and clearly indicates the state coincidence points “M11” to “M13” indicating the positions where the states are determined to synchronize.

The state coincidence point M11 indicates a state coincidence (i.e., such a state coincidence that the simultaneous state coincidence combination number Ns is “3”) among the meeting participants corresponding to graphs G12, G13, G14. Further, the state coincidence point M12 indicates a state coincidence (i.e., such a state coincidence that the simultaneous state coincidence combination number Ns is “1”) between the meeting participants corresponding to the graph G11 and the graph G14. Furthermore, the state coincidence point M13 indicates a state coincidence (i.e., such a state coincidence that the simultaneous state coincidence combination number Ns is “6”) among the meeting participants other than the meeting participants corresponding to the graph G13.

In this case, based on the state coincidence information Im, the meeting score calculation unit 37 recognizes that the state coincidence occurs in three timings, the simultaneous state coincidence combination number Ns at each timing is respectively 3, 1, and 6. Then, based on the sum (here “10”) of the simultaneous state coincidence combination numbers Ns at respective timings, the meeting score calculation unit 37 calculates the meeting score Sc. Here, as an example, the meeting score calculation unit 37 calculates the meeting score Sc based on a value (also referred to as “first calculated value”) obtained by adding the number (here, “10”) of pairs of the meeting participants with the state coincidence during the entire meeting time to the sum of the simultaneous state coincidence combination numbers Ns at respective timings. Since this first calculation value depends on the combination number N (here, “10”) of all meeting participants, in some embodiments, the meeting score calculation unit 37 calculates the meeting score Sc based on a value obtained by dividing the first calculated value by the combination number N of all meeting participants using a predetermined map or calculation formula. At this time, the meeting score calculation unit 37 determines the meeting score Sc so that the greater the value obtained by dividing the first calculated value by the combination number N of all meeting participants is, the higher the meeting score Sc becomes.

By determining the meeting score Sc as described above when the purpose of the meeting is a consensus formation, the meeting score calculation unit 37 can suitably calculate the meeting score Sc so that the meeting score Sc increases with the increase in the number of the meeting participants whose states are synchronized at the same timing. The meeting score calculation unit 37 may calculate the meeting score Sc based on a value obtained by dividing the sum (“10” in FIG. 5) of the simultaneous state coincidence combination numbers Ns for respective timings of the state coincidence by the combination number N of all meeting participants, instead of the first calculation value described above.

Further, in some embodiments, in the calculation approach of the meeting score Sc described above, the meeting score calculation unit 37 may calculate the meeting score Sc further considering the degree of proximity of each timing of the state coincidence corresponding to each simultaneous state coincidence combination number Ns to the finish time of the meeting. Specifically, the closer to the finish time of the meeting the timing of the state coincidence corresponding to the simultaneous state coincidence combination number Ns is, the larger weight coefficient the meeting score calculation unit 37 uses to multiply the simultaneous state coincidence combination number Ns. For example, the meeting score calculation unit 37 scales the time period of the meeting to a range from 0 to X (X is a positive integer) and multiplies each simultaneous state coincidence combination number Ns by the value, scaled to the range from 0 to X, of the corresponding timing (time) as a weighting coefficient. Therefore, in the example shown in FIG. 5, since the timing when the simultaneous state coincidence combination number Ns becomes “6” is close to the finish time of the meeting, the simultaneous state coincidence combination number Ns is multiplied by the value close to X. According to this example, considering that the latter occurrence of the state coincidence of the meeting participants is preferable in the meeting for the consensus formation, the meeting score calculation unit 37 determines the meeting score Sc by increasing the weight on the state coincidence with closing timing to the finish time of the meeting.

Here, a supplementary description will be given of the calculation method of the simultaneous state coincidence combination number Ns. For example, the meeting score calculation unit 37 refers to the state-coincidence time indicating the timing of the state coincidence for each pair of the meeting participants indicated by the state coincidence information Im supplied from the state coincidence determination unit 35, and determines that state coincidences of pairs of the meeting participants whose state-coincidence time is close to one another within a predetermined time length occur at the same timing. If the state coincidence information Im includes the information on the time slot as the information indicative of the above-described timing of the state coincidence, the meeting score calculation unit 37 determines that state coincidences of pairs of the meeting participants whose time slots overlap with one another occur at the same timing.

(4-3) Presentation

If the purpose of the meeting is a presentation, one presenter will continue to present the idea, and the other meeting participants will express their consent or opposition to the presentation. Therefore, in the present example embodiment, when the purpose of the meeting is a presentation, an ideal condition is defined to be a condition that the state of the presenter coincides with the states of the other meeting participants.

Considering the above, when the purpose of the meeting is a presentation, the meeting score calculation unit 37 sets the meeting score Sc so that the larger the number (also referred to as “presenter state coincidence combination number Np”) of combinations (pairs) of the presenter and another meeting participant with a state coincidence with the presenter, the higher the meeting score Sc becomes. In this case, in some embodiments, based on a value obtained by dividing the presenter state coincidence combination number Np by the number of all-possible pairs between the presenter and other meeting participants, the meeting score calculation unit 37 sets the meeting score Sc without dependence on the total number of meeting participants by referring to a predetermined equation or map. It is noted that the number of all-possible pairs between the presenter and other meeting participants is “n−1” when the number of meeting participants is “n”.

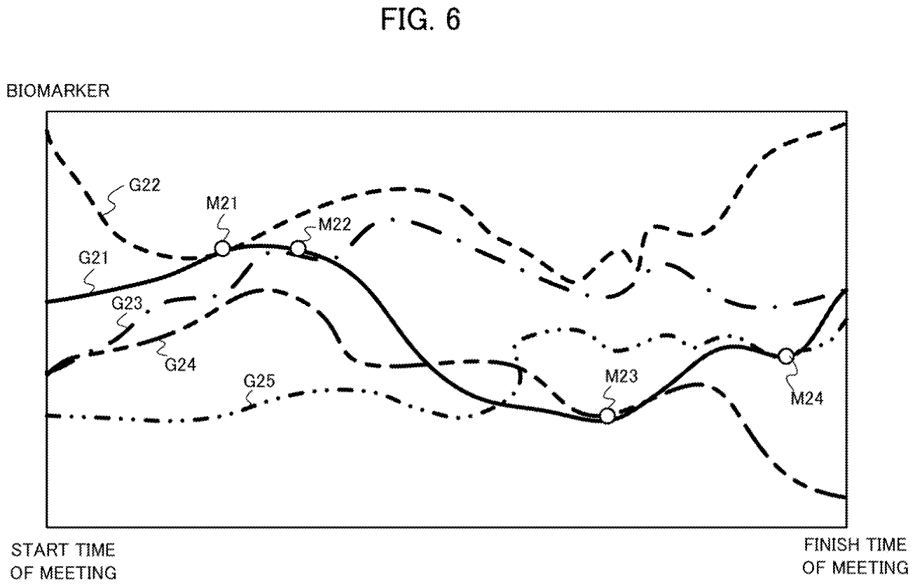

FIG. 6 is a graph showing the variation with time in the biomarker Idx of the meeting participants during the meeting when the purpose of the meeting is a presentation. FIG. 6 shows the biomarker Idx of the presenter by the graph “G21” and the biomarker Idx of the other meeting participants by the graphs “G22” to “G25” in the meeting held by five people. Further, FIG. 6 clearly shows the state coincidence points “M21” to “M24” indicating points at which the states are determined to be coincident between the presenter and any of other meeting participants.

In this case, after recognizing the presenter out of the meeting participants, the meeting score calculation unit 37 detects the state coincidence for pairs of the presenter and any of the other meeting participants by referring to the state coincidence information Im, thereby calculating the presenter state coincidence combination number Np. Here, the presenter state coincidence combination number Np is the same number “4” as the number of the state coincidence points M21 to M24. Then, the meeting score calculation unit 37 determines the meeting score Sc based on a value “1” (=4/4) obtained by dividing the calculated presenter state coincidence combination number Np by the total number (here “4”) of pairs of the presenter and any of other meeting participants. At this time, the meeting score calculation unit 37 refers to a predetermined equation or map, and determines the meeting score Sc so that the larger the value obtained by dividing the calculated presenter state coincidence combination number Np by the total number of pairs of the presenter and any of other meeting participants, the higher the meeting score Sc becomes. Thus, the meeting score calculation unit 37 can suitably determine the meeting score Sc so as to increase the meeting score Sc with increasing in the number of times that the presenter and another meeting participant have synchronized, when the purpose of the meeting is a presentation.

Here, a specific example of the recognition method of the presenter will be supplementally described. In the first example, the meeting information stored in the meeting information storage unit 20 includes the personal ID of the presenter designated at the time of the reservation of the meeting or the like when the purpose of the meeting is a presentation. Then, the meeting score calculation unit 37 refers to the meeting information of the target meeting and then recognizes the personal ID of the presenter. In the second example, the meeting score calculation unit 37 recognizes the presenter based on a signal outputted by a camera or a microphone or the like provided in the meeting room 5. For example, the meeting score calculation unit 37 analyzes an image outputted by a camera that captures a view during a meeting, and identifies the personal ID of the meeting participant standing near the view through biometric certification such as face certification as a personal ID indicating the presenter. In another example, the meeting score calculation unit 37 analyzes the voice signal outputted by the microphone provided in the meeting room 5, and identifies the personal ID of the meeting participant with the highest frequency of utterances through voiceprint authentication or the like as the personal ID indicating the presenter.

### (5) Processing Flow

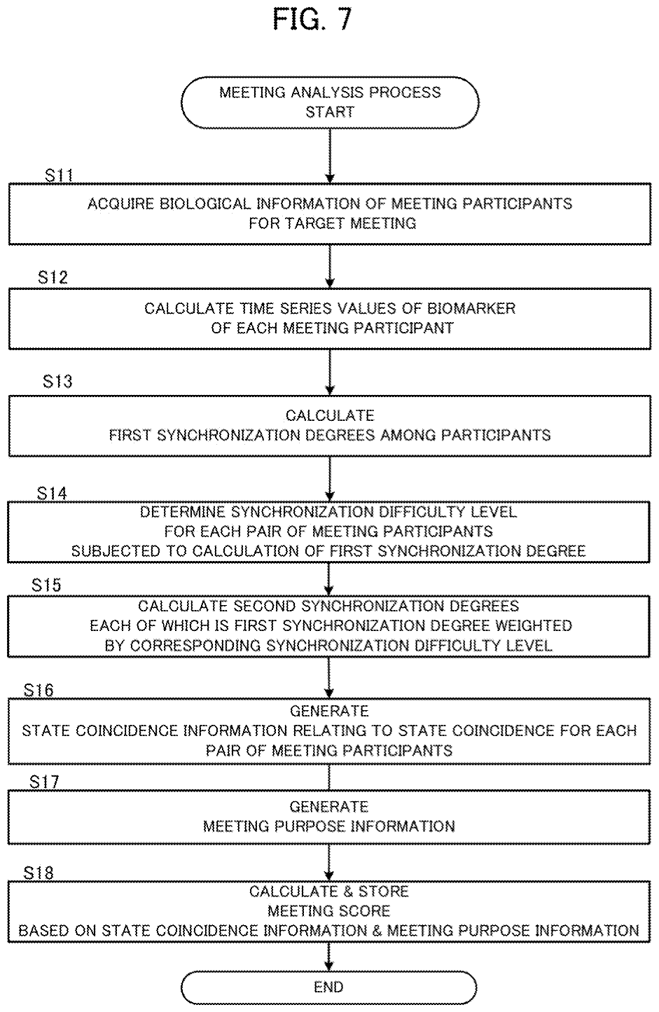

FIG. 7 is an example of a flowchart showing the procedure of meeting analysis process relating to calculation of the meeting score Sc. For example, when receiving the display request from the display terminal 4, the information processing device 1 executes the flowchart shown in FIG. 7 for a meeting designated by the display request. In another example, the information processing device 1 recognizes the time period of the meeting subject to calculation of the meeting score Sc by referring to the meeting information storage unit 20, and executes the flowchart shown in FIG. 7 for the meeting the time period of which has elapsed. In yet another example, the information processing device 1 executes the flowchart shown in FIG. 7 for such a meeting that the transmission of the detection signal S1 by the biological information detection sensor 3 is completed (stopped).

First, the biological information acquisition unit 30 of the information processing device 1 refers to the biological information storage unit 22 and acquires the biological information Ib of the meeting participants at a target meeting (step S11). Then, the biomarker calculation unit 31 calculates time series values of the biomarker Idx for each meeting participant from the biological information Ib acquired at step S11 (step S12).

Next, the first synchronization degree calculation unit 32 calculates the first synchronization degrees Ds1 among participants based on the time series values of the biomarker Idx of the meeting participants calculated at step S12 (step S13). In this case, when “n” denotes the number of participants in the target meeting, the first synchronization degree calculation unit 32 calculates the first synchronization degree Ds1 based on time-series values of the biomarker Idx of the meeting participants for each of ₙC₂ possible pairs of the meeting participants.

Next, the synchronization difficulty level determination unit 33 determines the synchronization difficulty level Dd for each possible pair of the meeting participants subjected to calculation of the first synchronization degree Ds1 (step S14). In this case, the synchronization difficulty level determination unit 33 refers to the attribute information of the meeting participants stored in the individual attribute information storage unit 21 and determines the synchronization difficulty level Dd based on the similarity between the attributes of the meeting participants with respect to each possible pairs of the meeting participants. Then, the second synchronization degree calculation unit 34 calculates the second synchronization degrees Ds2 each of which is the first synchronization degree Ds1 weighted by the corresponding synchronization difficulty level Dd (step S15). Thus, the information processing device 1 can suitably calculate the second synchronization degree Ds2 which is the synchronization degree considering the difficulty level of the synchronization estimated from the attributes of the meeting participants.

Next, the state coincidence determination unit 35 generates the state coincidence information Im relating to the state coincidence for each pair of the meeting participants based on the second synchronization degree Ds2 calculated by the second synchronization degree calculation unit 34 (step S16). In this case, the state coincidence determination unit 35 generates the state coincidence information Im by detecting a time or a time slot in which a state coincidence occurs for each pair of the meeting participants using the state coincidence threshold Dsth. Further, the meeting purpose determination unit 36 determines the purpose of the target meeting based on the meeting information stored in the meeting information storage unit 20 or based on the output signal during the meeting outputted by a camera or a microphone provided in the meeting room 5, and generates the meeting purpose information Io indicating the purpose of the target meeting (step S17).

Then, the meeting score calculation unit 37 calculates the meeting score Sc based on the state coincidence information Im generated at step S16 and the meeting purpose information Io generated at step S17 (step S18). Thus, the meeting score calculation unit 37 can suitably calculate the meeting score Sc for evaluating the quality of the target meeting according to the purpose of the meeting. In addition to this, at step S16, the meeting score calculation unit 37 stores, in the meeting analysis information storage unit 23, the meeting analysis information including the meeting score Sc and various information used for the calculation of the calculated meeting score Sc in association with the meeting ID of the target meeting. Thereafter, if the display control unit 38 receives the display request to be transmitted from the display terminal 4, the display control unit 38 generates the display signal S2 based on the meeting analysis information stored in the meeting analysis information storage unit 23 and transmits the generated display signal S2 to the display terminal 4 which is the transmission source of the display request.

(6) Display Example

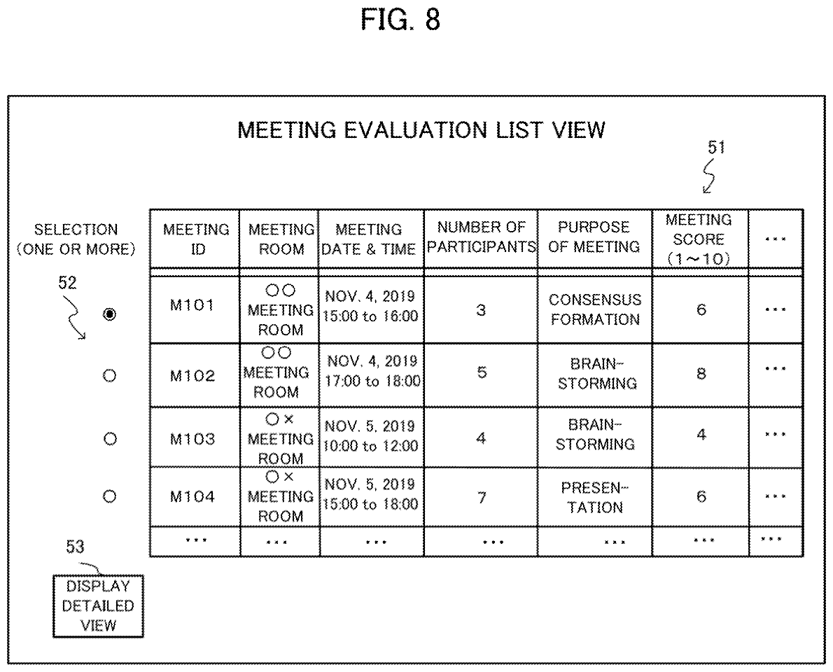

Next, display examples of the meeting evaluation view displayed on the display terminal 4 based on the display signal S2 generated by the information processing device 1 will be described with reference to FIGS. 8 to 10.

FIG. 8 is a display example of a meeting evaluation view (also referred to as “meeting evaluation list view”) showing a list of evaluations for a plurality of meetings. The display control unit 38 of the information processing device 1 transmits the display signal S2 to the display terminal 4 and thereby displays the meeting evaluation list view including a meeting list 51, a meeting selection button 52, and a detailed view display button 53 on the display terminal 4.

The meeting list 51 is a table showing a list of information on meetings for which the meeting scores were calculated, and mainly has items “meeting ID”, “meeting room”, “meeting date and time”, “number of participants”, “purpose of the meeting”, and “meeting score Sc”. For example, the display control unit 38 acquires the content of each item of the meeting ID, the meeting room, the meeting date and time, and the number of participants from the meeting information stored in the meeting information storage unit 20. Further, for example, the display control unit 38 acquires the purpose of the meeting and the meeting score Sc from the meeting analysis information stored in the meeting analysis information storage unit 23. Here, the meeting score Sc is, as an example, a 10-step evaluation from 1 to 10.

The meeting selection button 52 is a button group provided for each meeting listed in the meeting list 51, which allows multiple selections. FIG. 8 shows the situation where the meeting selection button 52 corresponding to the meeting with the meeting ID “M101” has been selected. The detailed view display button 53 is a button to display a view showing detailed analysis results of the meeting corresponding to the selected meeting selection button 52. When detecting the selection of the detailed view display button 53, the display control unit 38 generates a display signal S2 of a view indicating the detailed analysis result of the meeting corresponding to the selected meeting selection button 52, and transmits the display signal S2 to the display terminal 4.

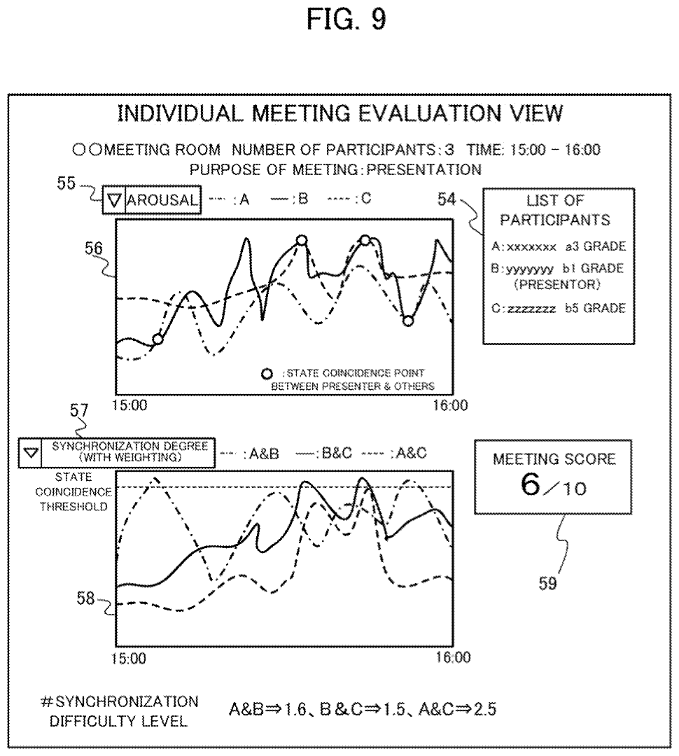

FIG. 9 is a display example of a meeting evaluation view (also referred to as “individual meeting evaluation view”) showing a detailed analysis result of one meeting (here, a meeting intended for presentation) selected on the meeting evaluation list view shown in FIG. 8. As a process for displaying the individual meeting evaluation view shown in FIG. 9, first, the display control unit 38 detects that the detailed view display button 53 is selected on the meeting evaluation list view shown in FIG. 8 in a state where the meeting selection button 52 corresponding to the meeting having the meeting ID “M101” has been selected. Then, the display control unit 38 generates the display signal S2 of the individual meeting evaluation view relating to the meeting with the meeting ID “M101”, and transmits the display signal S2 to the display terminal 4 thereby to display the individual meeting evaluation view shown in FIG. 9 on the display terminal 4.

Here, the display control unit 38 provides, on the individual meeting evaluation view, a participant list display field 54, a biomarker selection field 55, a biomarker display field 56, a synchronization degree selection field 57, a synchronization degree display field 58, and a meeting score display field 59. In the example of FIG. 9, the information processing device 1, as an example, determines the synchronization difficulty level Dd using the information on the grade of position which is one of the attribute information, and calculates the second synchronization degree Ds2 based on the determined synchronization difficulty level Dd. Hereafter, as an example, it is assumed that the grade of position is represented by a combination of a lower case alphabet (a to c) and a number (1 to 5) and that with lower case alphabet “a” represents the highest position and lower case alphabet “c” represents the lowest position. In addition, if the lower-case alphabet is the same, the lower the number is, the higher the grade of position becomes.

The participant list display field 54 shows a list of meeting participants in the target meeting. Here, the display control unit 38 displays, on the participant list display field 54, a combination of the name and the grade of the position of each meeting participant, and displays a unique capital alphabet (A to C) assigned to each meeting participant. Here, the display control unit 38 acquires information on the name and the grade of the position of each meeting participant based on, for example, the personal ID of each meeting participant stored in the meeting information storage unit 20 and the attribute information for each personal ID stored in the individual attribute information storage unit 21.

The biomarker selection field 55 is a field that the viewer selects the biomarker Idx to be displayed in the biometric display field 56. Here, as an example, the biomarker selection field 55 is a selection field according to the pull-down menu format, and accepts the selection of the biomarker Idx to be displayed on the biometric display field 56 from one or more types of the biomarker Idx that can be calculated from the biological information Ib of the meeting participants.

The biomarker display field 56 is a field for displaying graphs of the time-series values, during the meeting, of the biomarker Idx selected in the biomarker selection field 55. For example, the display control unit 38 acquires the time series data of the biomarker Idx, which is selected in the biomarker selection field 55, for each meeting participant from the meeting analysis information storage unit 23 or the like, and displays graphs showing the time series data for each meeting participant obtained on the two-dimensional coordinates of the selected biomarker Idx and time. Here, the display control unit 38 displays the time-series data of the degree of arousal of each meeting participant on the biomarker display field 56 in association with each of the upper-case alphabets allocated for each meeting participant in the participant list display field 54.

Further, the display control unit 38 display, on the graph in the biomarker display field 56, “o” marks indicating the state coincidence points between the presenter and other meeting participants that is used for the calculation of the meeting score Sc. Thus, the display control unit 38 can suitably present, to the viewer, state coincidence points between the presenter and the other meeting participants which are important in the evaluation of the meeting for the purpose of presentation. Even when the purpose of the target meeting is other than the presentation, the display control unit 38 displays marks indicating the state coincidence points between the meeting participants used for calculating the meeting score Sc according to the purpose of the target meeting. For example, when the purpose of the meeting is a brainstorming, the display control unit 38 displays marks of the state coincidence points corresponding to M1 to M7 in FIG. 4. In contrast, when the purpose of the meeting is a consensus formation, the display control unit 38 displays marks of the state coincidence points corresponding to M11 to M13 in FIG. 5.

The synchronization degree selection field 57 is a field for selecting the degree of synchronization (first synchronization degree Ds1 or second synchronization degree Ds2) to be displayed in the synchronization degree display field 58. The synchronization degree selection field 57 is a selection field in the pull-down menu format and accepts a selection of either the first synchronization degree Ds1, that is the degree of synchronization without weighting based on the synchronization difficulty level Dd, or the second synchronization degree Ds2, that is the degree of synchronization with the weighting based on the synchronization difficulty level Dd.

The synchronization degree display field 58 a field for displaying the time series graphs of the degree of synchronization (second synchronization degree Ds2 in FIG. 9) selected in the synchronization degree selection field 57 for all combinations (three pairs in FIG. 9) of the meeting participants. In the example of FIG. 9, the display control unit 38 refers to the meeting analysis information storage unit 23 and displays graphs showing transitions, during the meeting, of the second synchronization degree Ds2 corresponding to all combinations (three pairs) of the meeting participants. The display control unit 38 may display, on the synchronization degree display field 58, graphs showing the temporal transitions of the second synchronization degree Ds2 obtained by applying a smoothing process such as a moving average filter to the time-series second synchronization degree Ds2 registered in the meeting analysis information storage unit 23.

Further, the display control unit 38 clearly indicates, on the synchronization degree display field 58, the state coincidence threshold Dsth used for determining the state coincidence between the presenter and the other meeting participants. Thus, the display control unit 38 allows the viewer to easily grasp, even on the synchronization degree display field 58, the state coincidence points (i.e., points where the meeting participants are synchronized) among the meeting participants that are important in the evaluation of the meeting for the purpose of presentation.

Furthermore, below the synchronization degree display field 58, the display control unit 38 provides the synchronization difficulty level Dd used for each calculation of the second synchronization degree Ds2 corresponding to all possible pairs of meeting participants. In the example of FIG. 9, since the difference between the grades of the positions of the meeting participant A and the meeting participant C is the largest, the synchronization difficulty level Dd between the meeting participant A and the meeting participant C is set to the highest value (2.5). As described above, the display control unit 38 displays the transitions of the second synchronization degree Ds2 during the target meeting together with the synchronization difficulty level Dd used for weighting and thereby allows the viewer to appropriately grasp the effect of the weighting by the synchronization difficulty level Dd.

Furthermore, if the first synchronization degree Ds1 is selected in the synchronization degree selection field 57, the display control unit 38 displays, on the synchronization degree display field 58, graphs showing the transitions, during the meeting, of the first synchronization degree Ds1 corresponding to all combinations (three pairs) of the meeting participants. Therefore, the viewer can also favorably compare the first synchronization degree Ds1 and the second synchronization degree Ds2 by operating the synchronization degree selection field 57.

The meeting score display field 59 is a field for displaying the meeting score for the meeting of interest. Here, by referring to the meeting analysis information storage unit 23, the display control unit 38 displays the meeting score Sc (here “6”) for the target meeting. The display control unit 38 may display the ranking of the meeting scores among all meetings registered in the meeting analysis information of the meeting analysis information storage unit 23 in the meeting score display field 59 together with the meeting score.

Thus, the display control unit 38 can suitably display the biomarker Idx during the meeting specified by the viewer, the degree of synchronization with and without the weighting, the state coincidence points among the meeting participants, and the meeting score Sc. Thus, the viewer can refer to the individual meeting evaluation view and suitably evaluate the specified meeting.

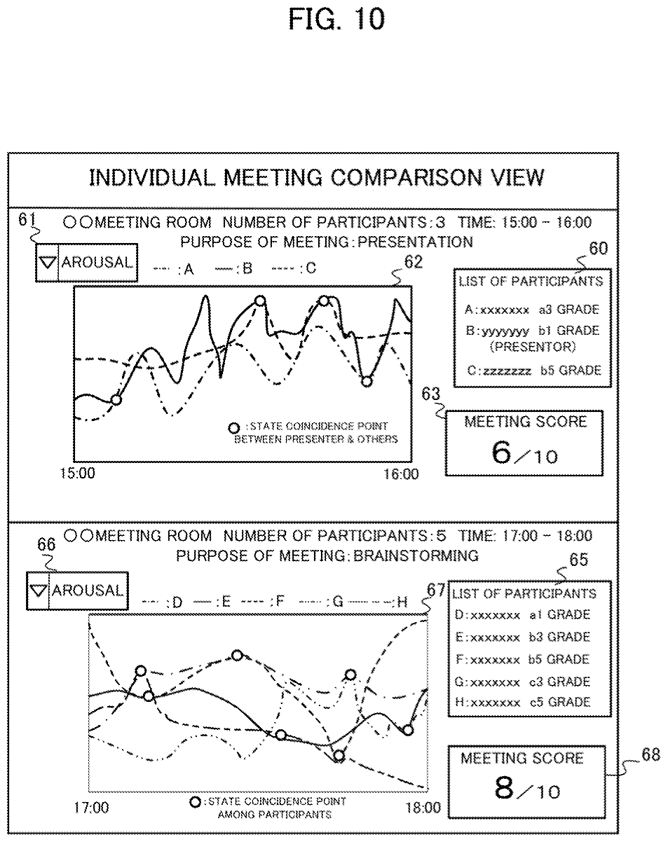

FIG. 10 is a display example of a meeting evaluation view (also referred to as “meeting evaluation comparison view”) showing an analysis result of each meeting when plural meetings are selected on the meeting evaluation list view. Here, in the meeting evaluation list view of FIG. 8, it is assumed that the detailed view display button 53 is selected in a state where the meeting selection button 52 of the meeting of the meeting ID “M101” and the meeting selection button 52 of the meeting of the meeting ID “M102” are selected. Then, the display control unit 38 generates a display signal S2 relating to the analysis result of each meeting of the meeting ID “M101” and “M102”, and transmits the display signal S2 to the display terminal 4, thereby displaying the meeting evaluation list view shown in FIG. 10 on the display terminal 4.

Here, with respect to the meeting ID “M101”, the display control unit 38 displays a participant list display field 60, a selection field 61, a graph display field 62, and a meeting score display field 63 on the upper side of the meeting evaluation comparison view. Further, with respect to the meeting ID “M102”, the display control unit 38 displays a participant list display field 65, a selection field 66, a graph display field 67, and a meeting score display field 68 on the lower side of the meeting evaluation comparison view.

The display control unit 38 displays the meeting participants of the meeting ID “M101” and the meeting participants of the meeting ID “M102” in the participant list display field 60 and the participant list display field 65, respectively. Further, the display control unit 38 accepts, through the selection field 61 and the selection field 66, the selections of the indicators to be displayed in the graph display field 62 and the graph display field 67, respectively. Here, each of the selection field 61 and the selection field 66 is a selection field in the pull-down menu format including items of various kinds of the biological indicator Idx, the first synchronization degree Ds1, and the second synchronization degree Ds2. Further, on the graph display field 62 and the graph display field 67, the display control unit 38 provides graphs each showing the time transition of the indicator (here the degree of arousal of each meeting participant) selected respectively in the selection field 61 and the selection field 66 and o marks indicating the state coincidence points among participants. Further, on the meeting score display field 63 and the meeting score display field 68, the display control unit 38 displays the meeting scores Sc of the meetings of the meeting ID “M101” and the meeting ID “M102”.

Thus, in the meeting evaluation comparison view, the display control unit 38 displays the meeting score Sc of a plurality of meetings selected by the viewer and the respective indicators such as the degree of synchronization used for the calculation of the meeting score Sc at the same time. Thus, the viewer can appropriately compare the analysis results of the selected meeting by referring to the meeting evaluation comparison view.

### Second Example Embodiment

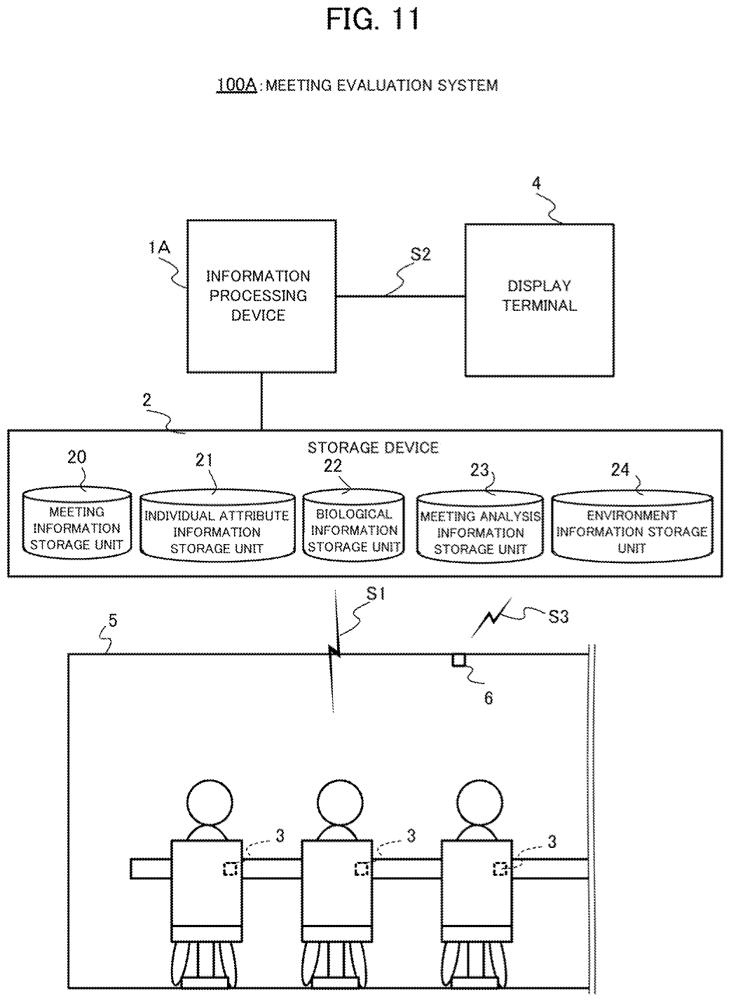

FIG. 11 shows the configuration of the meeting evaluation system 100A according to the second example embodiment. The meeting evaluation system 100A includes an environment detection sensor 6 provided in the meeting room 5. Then, the information processing device 1A according to the second example embodiment differs from the information processing device 1 according to the first example embodiment in that the state coincidence between the meeting participants is determined by considering the meeting environment on the basis of a signal outputted by the environment detecting sensor 6. Hereinafter, the same components as the first example embodiment are appropriately denoted by the same reference numerals as the first example embodiment, and the description thereof will be omitted as appropriate.

The environment detection sensor 6 is one or more sensors provided in the meeting room 5 and is used for environment detection in the meeting room 5. For example, the environment detection sensor 6 detects one or more types of indicators (environment indicators) regarding environment such as humidity, temperature, oxygen concentration, brightness to detect. Then, the environment detecting sensor 6 transmits a detection signal “S3” indicating the detected environment indicator to the information processing device 1A or the storage device 2.

The storage device 2 includes an environment information storage unit 24 in addition to the meeting information storage unit 20, the individual attribute information storage unit 21, the biological information storage unit 22, and the meeting analysis information storage unit 23 described in the first example embodiment. The environment information storage unit 24 stores environment information indicating one or more types of environment indicators in the meeting based on the detection signal S3 transmitted from the environment detection sensor 6. Here, the environment information stored in the environment information storage unit 24 may be time series data of the environment indicator detected during the meeting, or it may be a representative value such as the time average of the environment indicator detected during the meeting. When the detection signal S3 is transmitted to the information processing device 1A, the information processing device 1A stores the environment information indicated by the received detection signal S3 in the environment information storage unit 24.

The block configuration of the information processing device 1A and the display terminal 4 in the second example embodiment are according to FIGS. 2A and 2B, respectively, so the description thereof will be omitted. In the same way as the functional block shown in FIG. 3, the processor 11 in the second example embodiment functions as the biological information acquisition unit 30, the biomarker calculation unit 31, the first synchronization degree calculation unit 32, the synchronization difficulty level determination unit 33, the second synchronization degree calculation unit 34, the state coincidence determination unit 35, the meeting purpose determination unit 36, the meeting score calculation unit 37, and the display control unit 38.

Here, the second synchronization degree calculation unit 34 according to the second example embodiment determines the difficulty level (also referred to as “environment difficulty level De”) of synchronization in the aspect of environment of the meeting of interest by acquiring the environment information corresponding to the meeting from the environment information storage unit 24. In this case, for example, an equation or a map or the like, which associates possible values (combinations of values if the plural indicators are used) of one or more environment indicators stored as environment information with the environment difficulty level De to be set, is stored in advance in the memory 12 or the storage device 2. Then, by referring to the equation or map or the like, the second synchronization degree calculation unit 34 determines the environment difficulty level De based on one or more environment indicators indicated by the environment information for the meeting of interest obtained from the environment information storage unit 24. Here, the environment difficulty level De to be set increases with decreasing suitability (i.e., increasing severeness) of the environment indicators indicated by the acquired environment information for the meeting environment.

Then, the state coincidence determination unit 35 determines the state coincidence among the meeting participants based on the determined environment difficulty level De, the second synchronization degree Ds2 corresponding to all combinations (pairs) of the meeting participants, and the state coincidence threshold Dsth. For example, the state coincidence determination unit 35 sets the state coincidence threshold Dsth so that the higher the environment difficulty level De is, the lower the state coincidence threshold Dsth becomes. In this case, the information processing device 1A stores in advance a map or the like representing the relation between the environment difficulty level De and the state coincidence threshold Dsth in the memory 12 or the storage device 2, and sets the state coincidence threshold Dsth from the environment difficulty level De by referring to the map. In this way, the state coincidence determination unit 35 can determine whether or not there is a state coincidence among the meeting participants in consideration of the environment difficulty level De.

### Third Example Embodiment

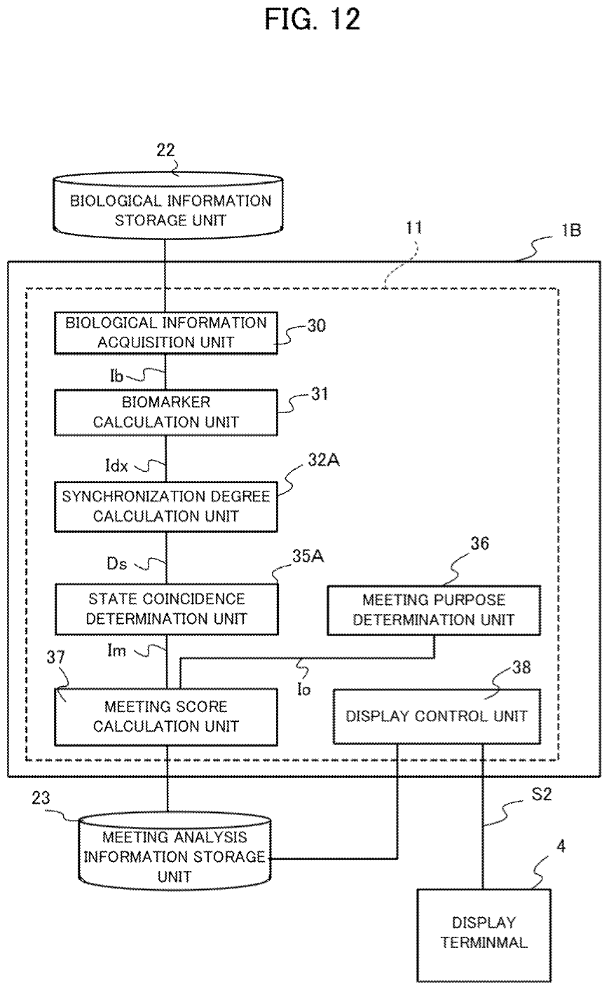

FIG. 12 is a functional block diagram of the processor 11 of the information processing device 1B according to the third example embodiment. The information processing device 1B according to the third example embodiment differs from the first example embodiment in that the degree of synchronization between the meeting participants is determined without considering the synchronization difficulty level Dd that is based on the individual attribute information. Hereinafter, the same components as the first example embodiment are appropriately denoted by the same reference numerals as the first example embodiment, and the description thereof will be omitted as appropriate. Further, the block configuration of the information processing device 1B and the display terminal 4 in the third example embodiment are according to FIGS. 2A and 2B, respectively, so the description thereof will be omitted.

The processor 11 functionally includes the biological information acquisition unit 30, the biomarker calculation unit 31, the synchronization degree calculation unit 32A, the state coincidence determination unit 35, the meeting purpose determination unit 36, the meeting score calculation unit 37, and the display control unit 38. The biological information acquisition unit 30, the biomarker calculation unit 31, the meeting purpose determination unit 36, the meeting score calculation unit 37, and the display control unit 38 perform the same process as the biological information acquisition unit 30, the biomarker calculation unit 31, the meeting purpose determination unit 36, the meeting score calculation unit 37, and the display control unit 38 according to the first example embodiment, respectively.

The synchronization degree calculation unit 32A calculates the degree (also referred to as “synchronization degree Ds”) of synchronization between meeting participants based on the time series data of the biomarker Idx, during the meeting, of the respective meeting participants generated by the biological indicator calculation unit 31. The synchronization degree Ds corresponds to the first synchronization degree Ds1 which the first synchronization degree calculation unit 32 calculates in the first example embodiment.

The state coincidence determination unit 35A detects, for each possible pair of the meeting participants, the time or time slot during a meeting in which the corresponding synchronization degree D is equal to or greater than the state coincidence threshold Dsth as the time or time slot in which the state coincidence between the meeting participants occurs. The state coincidence determination unit 35A supplies, for each possible pair of the meeting participants, the meeting score calculation unit 37 with information indicating the time or the time slot in which the state coincidence between the meeting participants occurs as the state coincidence information Im.

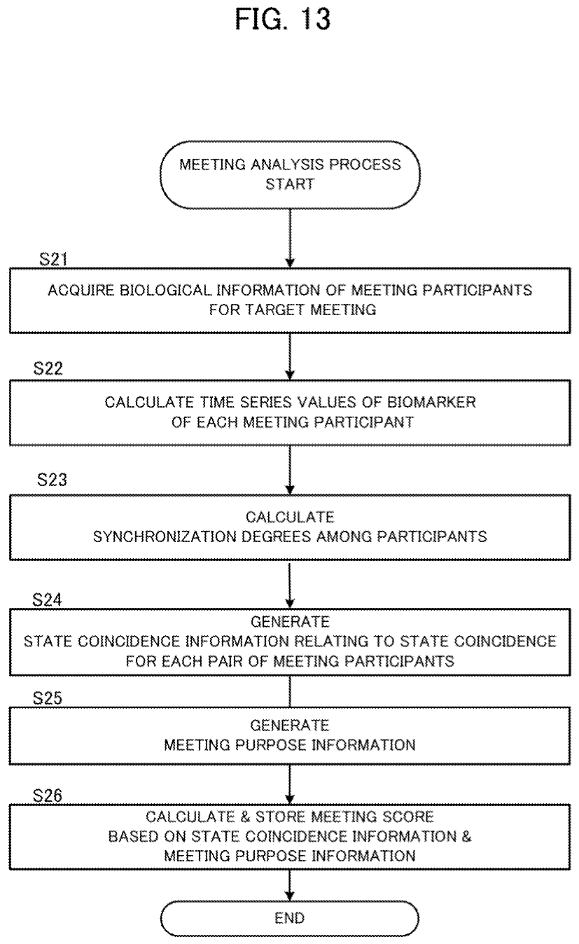

FIG. 13 is an example of a flowchart showing the procedure of the meeting analysis process in the third example embodiment.

First, the biological information acquisition unit 30 of the information processing device 1 refers to the biological information storage unit 22 and acquires the biological information Ib of the meeting participants at a target meeting (step S21). Then, the biomarker calculation unit 31 calculates time series values of the biomarker Idx of each meeting participant from the biological information Ib acquired at step S11 (step S22).

Next, the synchronization degree calculation unit 32A calculates the synchronization degree Ds among the participants based on the time series values of the biomarker Idx of the meeting participants calculated at step S12 (step S23). In this case, given that n denotes the number of participants in the meeting, the synchronization degree calculation unit 32A calculates the synchronization degree Ds based on the time series values of the biomarker Idx of the meeting participants for each of ₙC₂ combinations (pairs).

Next, the state coincidence determination unit 35 generates the state coincidence information Im relating to the state coincidence for each pair of the meeting participants on the basis of the synchronization degree Ds calculated by the synchronization degree calculation unit 32A (step S24). The meeting purpose determination unit 36 determines the purpose of the target meeting based on the meeting information stored in the meeting information storage unit 20, or based on the output signal outputted by a camera or a microphone provided in the meeting room 5, and generates the meeting purpose information Io indicating the purpose of the target meeting (step S25).

Then, the meeting score calculation unit 37 calculates the meeting score Sc based on the state coincidence information Im generated at step S24 and the meeting purpose information Io generated at step S25 (step S26). In addition to this, at step S26, the meeting score calculation unit 37 stores the meeting analysis information including the meeting score Sc and various information used for the calculation of the calculated meeting score Sc in the meeting analysis information storage unit 23 in association with the meeting ID of the target meeting.

As described above, even in the third example embodiment, the information processing device 1B can determine the state coincidence among participants by referring to the synchronization degree Ds based on the biomarker Idx of the meeting participants, and accurately calculate the meeting score Sc according to the purpose of the meeting.

### Fourth Example Embodiment

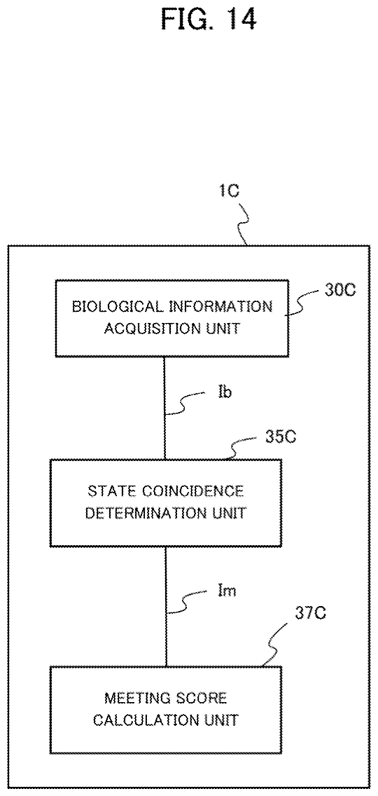

FIG. 14 is a schematic configuration diagram of an information processing device 1C according to a fourth example embodiment. As shown in FIG. 14, the information processing device 1C mainly includes the biological information acquisition unit 30C, the state coincidence determination unit 35C, and the meeting score calculation unit 37C.

The biological information acquisition unit 30C is configured to acquire biological information Ib of multiple participants in a meeting. Examples of the biological information acquisition unit 30B include the biological information acquisition unit 30 according to the first example embodiment, the second example embodiment, and the third example embodiment.

The state coincidence determination unit 35C is configured to determine, based on the biological information Ib, whether or not there is a state coincidence among the multiple participants in the meeting and generate the state coincidence information Im relating to the state coincidence. Examples of the state coincidence determination unit 35C include: a combination of the biomarker calculation unit 31, the first synchronization degree calculation unit 32, the synchronization difficulty level determination unit 33, the second synchronization degree calculation unit 34, and the state coincidence determination unit 35 according to the first or second example embodiment; and a combination of the biomarker calculation unit 31, the synchronization degree calculation unit 32A, and the state coincidence determination unit 35A according to the third example embodiment. It is noted that the state coincidence determination unit 35C may not perform the conversion process from the biological information Ib to the biomarker Idx by the biomarker calculation unit 31 according to the first to third example embodiments. In this case, for example, the state coincidence determination unit 35C may apply similarity calculation algorithm for time series data, such as a cross-correlation function described in the first example embodiment, to the time series data of the biological information Ib of two participants, thereby calculating the first synchronization degree Ds1 in the first and second example embodiments or the synchronization degree Ds in the third example embodiment.

The meeting score calculation unit 37C is configured to calculate, based on the state coincidence information Im, a meeting score Sc indicating an evaluation of a quality of the meeting according to a purpose of the meeting. Examples of the meeting score calculation unit 37C include the meeting purpose determination unit 36 and the meeting score calculation unit 37 in the first example embodiment, the second example embodiment, or the third example embodiment.

According to the configuration of the third example embodiment, the information processing device 1C can accurately calculate the meeting score Sc indicating the evaluation of the quality of the target meeting according to the purpose of the meeting.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An information processing device comprising:

a biological information acquisition unit configured to acquire biological information of multiple participants in a meeting;

a state coincidence determination unit configured to determine, based on the biological information, whether or not there is a state coincidence among the multiple participants in the meeting and generate state coincidence information relating to the state coincidence; and

a meeting score calculation unit configured to calculate, based on the state coincidence information, a meeting score indicating an evaluation of a quality of the meeting according to a purpose of the meeting.

[Supplementary Note 2]

The information processing device according to Supplementary Note 1,

wherein, if the purpose of the meeting is a brainstorming, the meeting score calculation unit is configured to calculate the meeting score based on
a degree of variation in a timing of the state coincidence among the multiple participants during a time period of the meeting.

[Supplementary Note 3]

The information processing device according to Supplementary Note 2,

wherein, if the purpose of the meeting is a brainstorming, the meeting score calculation unit is configured to calculate the meeting score based on
the degree of the variation and
the number of pairs of the participants with the state coincidence.

[Supplementary Note 4]

The information processing device according to Supplementary Note 1,

wherein, if the purpose of the meeting is a consensus formation, the meeting score calculation unit is configured to calculate the meeting score based on
the number of pairs of the participants with the state coincidence at each timing when the state coincidence occurs.

[Supplementary Note 5]

The information processing device according to Supplementary Note 4,

wherein, if the purpose of the meeting is a consensus formation, the meeting score calculation unit is configured to calculate the meeting score based on
the number of pairs of the participants with the state coincidence at each timing when the state coincidence occurs and
a degree of proximity of the each timing to a finish time of the meeting.

[Supplementary Note 6]

The information processing device according to Supplementary Note 1,

wherein, if the purpose of the meeting is a presentation, the meeting score calculation unit is configured to calculate the meeting score based on
the state coincidence information relating to the state coincidence between
   a presenter included in the multiple participants and
   the multiple participants other than the presenter.

[Supplementary Note 7]

The information processing device according to any one of Supplementary Notes 1 to 6, further comprising

a synchronization degree calculation unit configured to calculate, based on the biological information, a degree of synchronization between the multiple participants in the meeting,

wherein the state coincidence determination unit is configured to determine that the state coincidence occurs between participants whose degree of synchronization is equal to or higher than a predetermined threshold

[Supplementary Note 8]

The information processing device according to Supplementary Note 7, further comprising

a biomarker calculation unit configured to calculate, based on the biological information of each of the multiple participants, time series data of a biomarker that is an indicator representing a state of each of the multiple participants, and

wherein the synchronization degree calculation unit configured to calculate the degree of synchronization based on a correlation of the time series data between the multiple participants.

[Supplementary Note 9]

The information processing device according to Supplementary Note 7 or 8, further comprising

a synchronization difficulty level determination unit configured to determine, based on attribute information of the multiple participants, a synchronization difficulty level that is a difficulty level of the synchronization between the multiple participants,

wherein the synchronization degree calculation unit is configured to calculate the degree of the synchronization weighted based on the synchronization difficulty level.

[Supplementary Note 10]

The information processing device according to any one of Supplementary Notes 1 to 9, further comprising

a display control unit configured to display the meeting score on a display unit.

[Supplementary Note 11]

The information processing device according to Supplementary Note 10,

wherein the display control unit is configured to display on the display unit, together with the meeting score,
a degree of synchronization between the multiple participants or
a transition, during the meeting, of a biomarker that is an indicator representing a state of each of the multiple participants

in a state where one or more point of occurrence of the state coincidence are indicated.

[Supplementary Note 12]

The information processing device according to Supplementary Note 10,

wherein the display control unit is configured to display on the display unit
a list of information corresponding to multiple meetings,

the information including the purpose of each of the multiple meetings and the meeting score for each of the multiple meetings.

[Supplementary Note 13]

The information processing device according to any one of Supplementary Notes 1 to 12,

wherein the state coincidence determination unit is configured to generate the state coincidence information based on
the biological information and
environment information detected in a meeting room of the meeting.

[Supplementary Note 14]

A control method executed by an information processing device, the control method comprising:

acquiring biological information of multiple participants in a meeting;

determining, based on the biological information, whether or not there is a state coincidence among the multiple participants in the meeting and generate state coincidence information relating to the state coincidence; and

calculating, based on the state coincidence information, a meeting score indicating an evaluation of a quality of the meeting according to a purpose of the meeting.

[Supplementary Note 15]

A storage medium storing a program executed by a computer, the program causing the computer to function as:

a biological information acquisition unit configured to acquire biological information of multiple participants in a meeting;

a state coincidence determination unit configured to determine, based on the biological information, whether or not there is a state coincidence among the multiple participants in the meeting and generate state coincidence information relating to the state coincidence; and

a meeting score calculation unit configured to calculate, based on the state coincidence information, a meeting score indicating an evaluation of a quality of the meeting according to a purpose of the meeting.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A to 1C Information processing device
2 Storage device
3 Biometric detection sensor
4 Display terminal
5 Meeting room
6 Environment detection sensor
100, 100A Meeting evaluation system

What is claimed is:

1. An information processing device comprising:
at least one memory configured to store instructions; and
at least one processor configured to execute the instructions to
acquire biological information of multiple participants in a meeting;
determine, based on the biological information, whether or not there is a state coincidence among the multiple participants in the meeting and generate state coincidence information relating to the state coincidence; and
calculate, based on the state coincidence information, a meeting score indicating an evaluation of a quality of the meeting according to a purpose of the meeting.

2. The information processing device according to claim 1,
wherein, if the purpose of the meeting is a brainstorming, the at least one processor is configured to execute the instructions to calculate the meeting score based on
a degree of variation in a timing of the state coincidence among the multiple participants during a time period of the meeting.

3. The information processing device according to claim 2,
wherein, if the purpose of the meeting is a brainstorming, the at least one processor is configured to execute the instructions to calculate the meeting score based on
the degree of the variation and
the number of pairs of the participants with the state coincidence.

4. The information processing device according to claim 1,
wherein, if the purpose of the meeting is a consensus formation, the at least one processor is configured to execute the instructions to calculate the meeting score based on
the number of pairs of the participants with the state coincidence at each timing when the state coincidence occurs.

5. The information processing device according to claim 4,
wherein, if the purpose of the meeting is a consensus formation, the at least one processor is configured to execute the instructions to calculate the meeting score based on
the number of pairs of the participants with the state coincidence at each timing when the state coincidence occurs and
a degree of proximity of the each timing to a finish time of the meeting.

6. The information processing device according to claim 1,
wherein, if the purpose of the meeting is a presentation, the at least one processor is configured to execute the instructions to calculate the meeting score based on
the state coincidence information relating to the state coincidence between
a presenter included in the multiple participants and
the multiple participants other than the presenter.

7. The information processing device according to claim 1,
wherein the at least one processor is configured to execute the instructions to further calculate, based on the biological information, a degree of synchronization between the multiple participants in the meeting,
wherein the at least one processor is configured to execute the instructions to determine that the state coincidence occurs between participants whose degree of synchronization is equal to or higher than a predetermined threshold

8. The information processing device according to claim 7,
wherein the at least one processor is configured to execute the instructions to further calculate, based on the biological information of each of the multiple participants, time series data of a biomarker that is an indicator representing a state of each of the multiple participants, and
wherein the at least one processor is configured to execute the instructions to calculate the degree of synchronization based on a correlation of the time series data between the multiple participants.

9. The information processing device according to claim 7,
wherein the at least one processor is configured to execute the instructions to further determine, based on attribute information of the multiple participants, a synchronization difficulty level that is a difficulty level of the synchronization between the multiple participants,
wherein the at least one processor is configured to execute the instructions to calculate the degree of the synchronization weighted based on the synchronization difficulty level.

10. The information processing device according to claim 1,
wherein the at least one processor is configured to execute the instructions to further to display the meeting score on a display unit.

11. The information processing device according to claim 10,
wherein the at least one processor is configured to execute the instructions to display on the display unit, together with the meeting score,
a degree of synchronization between the multiple participants or
a transition, during the meeting, of a biomarker that is an indicator representing a state of each of the multiple participants
in a state where one or more point of occurrence of the state coincidence are indicated.

12. The information processing device according to claim 10,
wherein the at least one processor is configured to execute the instructions to display on the display unit
a list of information corresponding to multiple meetings,
the information including the purpose of each of the multiple meetings and the meeting score for each of the multiple meetings.

13. The information processing device according to claim 1,
wherein the at least one processor is configured to execute the instructions to generate the state coincidence information based on
the biological information and
environment information detected in a meeting room of the meeting.

14. A control method executed by an information processing device, the control method comprising:
acquiring biological information of multiple participants in a meeting;
determining, based on the biological information, whether or not there is a state coincidence among the multiple participants in the meeting and generate state coincidence information relating to the state coincidence; and
calculating, based on the state coincidence information, a meeting score indicating an evaluation of a quality of the meeting according to a purpose of the meeting.

15. A non-transitory computer readable storage medium storing a program executed by a computer, the program causing the computer to:
acquire biological information of multiple participants in a meeting;
determine, based on the biological information, whether or not there is a state coincidence among the multiple participants in the meeting and generate state coincidence information relating to the state coincidence; and
calculate, based on the state coincidence information, a meeting score indicating an evaluation of a quality of the meeting according to a purpose of the meeting.
